(19) United States
(12) Patent Application Publication
(10) Pub. No.: US 2011/0032585 A1
(43) Pub. Date: Feb. 10, 2011

(54) IMAGE READING APPARATUS, METHOD FOR CONTROLLING IMAGE READING APPARATUS, AND RECORDING MEDIUM

(75) Inventor: Aya Kasahara, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/849,195

(22) Filed: Aug. 3, 2010

(30) Foreign Application Priority Data
Aug. 4, 2009 (JP) 2009-181312

(51) Int. Cl. H04N 1/04

(52) U.S. Cl. 358/498

(57) ABSTRACT

If failure occurs in a part of reading units during a document reading operation, a user restarts an image reading apparatus to allow resuming the reading operation from the image of the document next to the image of the already read document. An image reading apparatus determines whether reading operation for reading the document can be resumed by using a first reading unit or a second reading unit if failure occurs in at least one of the first reading unit and the second reading unit during the reading operation, and causes a nonvolatile memory to store an image of a document already read by the reading operation and the image reading apparatus to restart if the reading operation can be resumed.

### BACKGROUND OF THE INVENTION

1. Field of the Invention

The present invention relates to an image reading apparatus, a method for controlling the image reading apparatus, and a recording medium.

2. Description of the Related Art

There is an image reading apparatus including an automatic document feeder (ADF) for conveying a document placed thereon one by one and reads the image of the document to be conveyed. There is another image reading apparatus reading the images of front and back sides of a two-sided document using the ADF and separate reading units. Such an image reading apparatus can perform quick reading of a document because there is no need to change the front and back sides of the document.

Some conventional image reading apparatuses are brought into a non-operation state if a paper jam occurs therein, and interrupts reading a document. Japanese Patent Application Laid-Open No. 11-122410, for example, discusses a method in which, if a paper jam occurs in an image reading apparatus, an image is not read until the paper jam is removed, and the reading of the image is resumed after the paper jam is removed.

In the conventional image reading apparatus, it is assumed that reading is resumed when reading is interrupted due to a paper jam. It is not assumed that reading is resumed when the reading unit of an image reading apparatus breaks down. For this reason, the conventional image reading apparatus cannot deal with the following problem.

The conventional image reading apparatus does not read a document if one reading unit of a document reading apparatus is broken down, while the other reading unit thereof is not broken down. Restarting the image reading apparatus allows using the other reading unit that is not broken down if the one reading unit fails, however, reading operation is not performed until the failure of the reading unit is eliminated.

Restarting the image reading apparatus to resume the reading operation of the document using a reading unit that is not broken down may inadvertently delete the already read image of the document.

### SUMMARY OF THE INVENTION

According to an aspect of the present invention, an image reading apparatus includes a reading unit configured to execute a reading operation in which a first side of a document conveyed by an automatic document feeder is read by using a first reading unit and a second side of the document is read by using a second reading unit, a determining unit configured to determine whether the reading operation can be resumed by using the first reading unit or the second reading unit by restarting the image reading apparatus if failure occurs in at least one of the first reading unit and the second reading unit during the reading operation, and a control unit configured to cause a nonvolatile memory to store an image of the document already read by the reading operation and the image reading apparatus to restart if reading operation can be resumed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image reading apparatus according to an exemplary embodiment of the present invention.

FIG. 2 is a cross section illustrating a document reading unit 1.

FIG. 3 is a flow chart illustrating data processing procedure in the image reading apparatus.

FIG. 4 is illustrates a user interface displayed on a display unit 9.

FIG. 5 illustrates a user interface displayed on the display unit 9.

FIG. 6 is a flow chart illustrating data processing in the image reading apparatus.

FIG. 7 illustrates a user interface displayed on the display unit 9.

FIG. 8 illustrates a user interface displayed on the display unit 9.

FIG. 9 illustrates a user interface displayed on the display unit 9.

FIG. 10 illustrates a user interface displayed on the display unit 9.

FIG. 11 illustrates a user interface displayed on the display unit 9.

### DESCRIPTION OF THE EMBODIMENTS

Various exemplary embodiments, features, and aspects of the invention will be described in detail below with reference to the drawings.

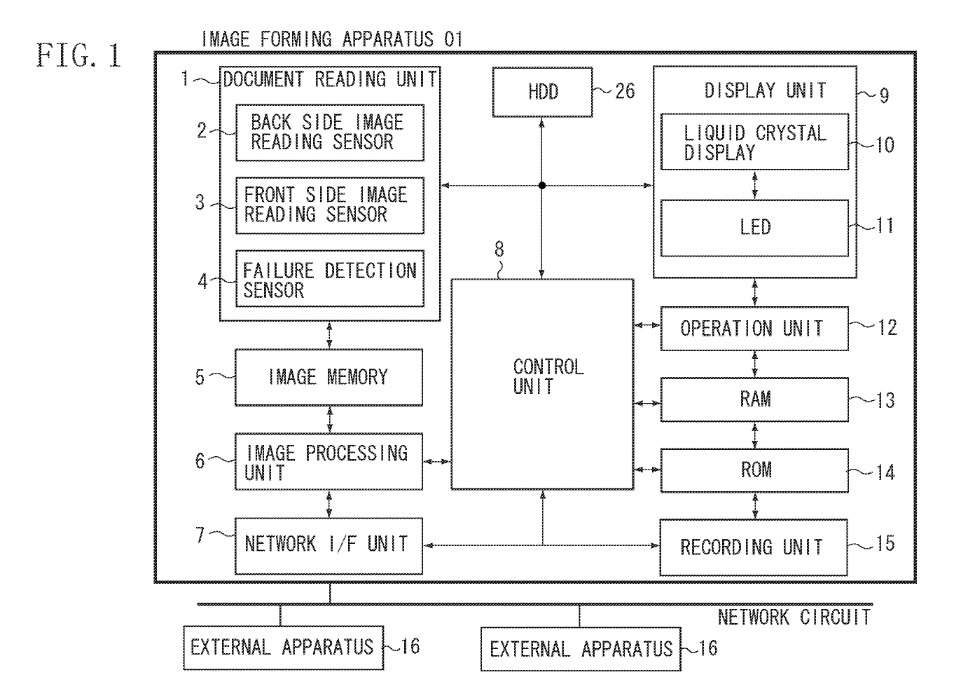

FIG. 1 is a block diagram illustrating a configuration of an image processing system including an image reading apparatus according to the present exemplary embodiment. The present exemplary embodiment is described using an image forming apparatus including a scanner as an example of an image reading apparatus.

In FIG. 1, an image forming apparatus includes a document reading unit 1, an image memory 5, an image processing unit 6, a network I/F unit 7, a control unit 8, a display unit 9, an operation unit 12, a RAM 13, a ROM 14, and a recording unit 15. The image forming apparatus is connected to a network circuit via a network I/F unit 7. One or more external apparatuses 16 exist on the network circuit.

The document reading unit 1 includes a front side image reading sensor 3 (a first reading unit) for reading image data on the front side (a first surface) of a document and a back side image reading sensor 2 (a second reading unit) for reading image data on the back side (a second surface) of a document. The document reading unit 1 further includes a failure detection sensor 4 for detecting failure occurring in the front side image reading sensor 3 and the back side image reading sensor 2.

The failure detection sensor 4 can detect a breakdown (a failure and an error) of the front side image reading sensor 3, the back side image reading sensor 2, and an automatic document feeder (ADF) 18 to be described below. In other words, the failure detection sensor 4 can detect whether the function for reading a document, which is fed from a document feeding apparatus, by the front side image reading sensor 3 and the back side image reading sensor 2, is working normally.

For example, if the front side image reading sensor 3 or the backside image reading sensor 2 does not send a signal to the failure detection sensor 4, the failure detection sensor 4 detects that the image reading sensor that does not send a signal does not operate normally.

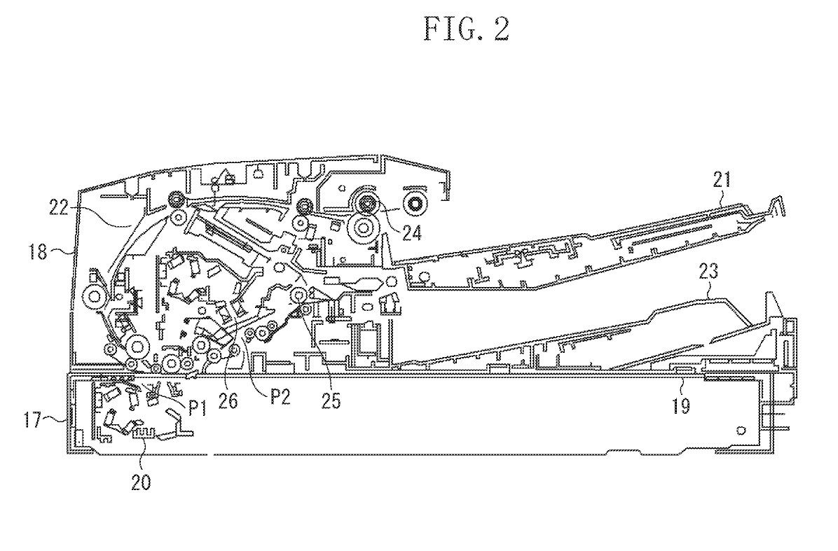

The failure detection sensor 4 detects whether the ADF 18 illustrated in FIG. 2 malfunctions. If a feeding roller of the ADF 18 does not normally operate, the failure detection sensor 4 detects that an error occurs in a feeding state of the ADF 18.

The failure detection sensor 4 can detect the breakdown of the front side image reading sensor 3, the back side image reading sensor 2, and the automatic document feeder (ADF) 18 while reading a document.

The front side image reading sensor 3 is provided on a document scanning unit for scanning a document at a predetermined speed to read an image of a one-sided document laid on a document positioning plate. The front side image reading sensor 3 reads image data formed by a CCD image sensor and outputs the read image data to an image memory 5.

If the image of a document is read by using the ADF 18, the front side image reading sensor 3 is fixed to a feeding-reading position on a housing to read the image of a document conveyed by the ADF 18.

The back side image reading sensor 2 reads the image on the back side of a document conveyed by the ADF 18, and outputs the read image data to the image memory 5. The document reading unit 1 may be provided with a size detection sensor for detecting the size of a document laid on the document positioning plate.

The operation unit 12 includes a touch panel for receiving user's instructions. The operation unit 12 further includes various hard keys such as a start key whereby a user instructs the document reading unit 1 to start reading a document, a ten key for inputting the number of copies, and cursor key for performing various settings.

The display unit 9 includes a liquid crystal display (LCD) 10 for displaying various setting screens and operation conditions of the image forming apparatus by characters and figures, and an LED 11 for notifying whether or not failure occurs in the image forming apparatus by turning on or off itself. The touch panel unit of the operation unit 12 and liquid crystal display 10 are integrally formed. The screen displayed on the display unit 9 is displayed and controlled by the control unit 8.

The control unit 8 controls the operation of each unit in the image forming apparatus. The ROM 14 stores various programs for the control unit 8 controlling the operation of each unit in the image forming apparatus. The RAM 13 is a memory for storing setting information and operational information used for the processing operation of the image forming apparatus 01 in a readable and writable state of various data.

The image memory 5 is a volatile memory such as a DRAM and stores images of image data output from the document reading unit 1. The image processing unit 6 reads image data from the image memory 5 and processes an image in accordance with instructions from the control unit 8 based on various settings on the display unit 9.

The image processing unit 6 edits the image data of a document read using a first sensor or a second sensor after the restart processing of the image forming apparatus and the image data read before the restart processing and stored in the image memory 5 into one image data.

The term “editing into one image data” refers to the combination of the image data of the document read after the restart processing and the image data of the document read before the restart processing into one file, and the store of combined image data. The image data of the document read after the restart processing and the image data of the document read before the restart processing may be stored with being associated with each other instead of managing the image data as one file.

The user can instruct the operation unit 12 to transmit and print the edited image data, and store it in the image memory 5.

The recording unit 15 records the image data subjected to image processing by the image processing unit 6 on a predetermined sheet (paper). The network I/F unit 7 has a function to receive a print job from the external apparatus 16. When the network I/F unit 7 receives a print job from the external apparatus 16, printing is performed using the control unit 8, the image processing unit 6, and the recording unit 15.

In the present exemplary embodiment, although the image forming apparatus is described with a multifunction peripheral including the recording unit 15 in addition to the document reading unit 1 taken as an example, the image forming apparatus does not necessarily need to include the recording unit 15.

The HDD 16 stores the image of a document read by the document reading unit 1. The HDD 16 is a nonvolatile memory. Data stored in the HDD 16 does not disappear even if electric power is not supplied to the HDD 16.

FIG. 2 is a cross section illustrating the document reading unit 1 illustrated FIG. 1. As illustrated in FIG. 2, the document reading unit 1 includes an automatic document feeder (ADF) that automatically feeds and conveys a plurality of documents laid on a document tray 21 one by one.

In FIG. 2, the document reading unit 1 includes a flat bed reading unit 17 and an automatic document feeder (ADF) 18 openably and closably attached to the flat bed reading unit 17. The flat bed reading unit 17 includes a transparent document positioning plate (a platen or a document stand) 19 on which a document is laid, and a front side image reading sensor 20.

The automatic document feeder (ADF) 18 includes the document tray 21 on which one or a plurality of documents are laid, and a laterally-facing U-shaped conveyance path 22, which is a conveyance path used for a document to be conveyed one by one from the document tray 21.

The ADF 18 further includes a discharge tray 23 into which a conveyed document is discharged and a sheet feeding roller 24 for feeding the document on the document tray 21 into the conveyance path. The ADF 18 still further includes a discharge roller 25 provided in the vicinity of the outlet of the conveyance path and a fixed back-side image reading sensor 26 for reading an image on the back side of a document at a reading position.

When a two-sided document is read by the document reading unit 1, as illustrated in FIG. 2, the document laid on the document tray 21 by the user is fed into the conveyance path 22 by the sheet feeding roller 24. The document fed into the conveyance path 22 from the document tray 21 is turned in a U shape from the upper side to the lower side along the conveyance path and reaches a reading position P1.

When the document passes the reading position P1, the image data on the front side of the document is read by the front side image reading sensor 20. When the document passes the reading position P2 while being conveyed along the conveyance path 22, the image data on the back side of the document is read by the back side image reading sensor 26. Thereafter, the document is discharged into the discharge tray 23 disposed under the document tray 21.

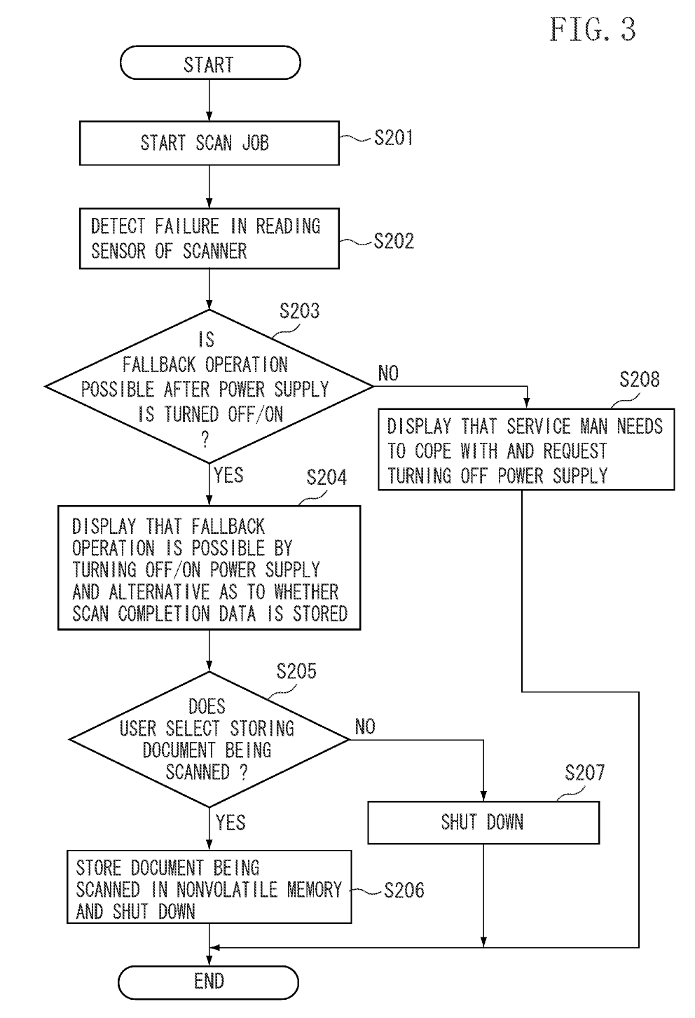

A process flow is described below with reference to FIG. 3 in the case where failure occurs in the front side image reading sensor 3, the back side image reading sensor 2 in the image reading apparatus, or the automatic document feeder (ADF) 18 while a document is being read in the image forming apparatus configured as described above.

If a failure occurs while the image of a document is being read, the image forming apparatus temporarily interrupts a processing operation. After that, the image forming apparatus is restarted by a user's instruction or after a lapse of a predetermined time period to recover the failure.

FIG. 3 is a flow chart illustrating an example of data processing in the image forming apparatus according to the present exemplary embodiment. Steps S201 to S208 are realized by the control unit 8 loading the control program stored in the ROM 14 into the RAM 13 and executing it.

In step S201, the control unit 8 receives a reading setting for reading an image from the user via the operation unit 12. The reading setting includes the setting of reading resolution and color/monochrome reading. The user performs the reading setting and lays a document on the ADF 18.

When a document is laid on the ADF 18 and the control unit 8 is instructed to start reading through the start button of the operation unit 12, the control unit 8 starts reading the document using the ADF 18 based on the reading setting. At this point, the control unit 8 generates a scan job based on the received reading setting to control the reading of the document according to the generated scan job.

The control unit 8 instructed to start reading detects whether the document is laid on the document tray 21 or the document positioning plate 19 of the document reading unit 1, and starts reading the document laid on either side. If documents are laid both on the document tray 21 and on the document positioning plate 19, the control unit 8 prompts the user to remove either of the documents via the display unit 9.

In step S202, the control unit 8 detects a failure in the front side image reading sensor 3, the back side image reading sensor 2, or the automatic document feeder (ADF) 18 through the failure detection sensor 4 in the document reading unit 1. If the control unit 8 does not detect failure, the control unit 8 continues reading the document.

If the failure detection sensor 4 detects that failure occurs in a reading function, the control unit 8 determines whether the reading of the document can be continued by performing a restart processing using a reading function in which failure does not occur.

For example, the control unit 8 performs determination as described in the following cases (1) to (7) according to the kinds of failure.

(1) If failure does not occur in the ADF 18 and the back side image reading sensor 2, but occurs in the front side image reading sensor 3, the control unit 8 determines that the document can be continuously read using the back side image reading sensor 2 and the ADF 18 in which failure does not occur. In this case, the user sets the document on the ADF 18 to cause the back side image reading sensor 2 to read the document one side by one side after the image forming apparatus is restarted, thereby allowing an image to be continuously read with the document set on the ADF 18. (Reading operation can be continued)

(2) If failure does not occur in the ADF 18 and the front side image reading sensor 3, but occurs in the back side image reading sensor 2, the control unit 8 determines that the document can be continuously read using the front side image reading sensor 3 and the ADF 18 in which failure does not occur. In this case, the user sets the document on the ADF 18 to cause the front side image reading sensor 3 to read the document one side by one side after the image forming apparatus is restarted, thereby allowing an image to be continuously read with the document set on the ADF 18. (Reading operation can be continued)

(3) If failure does not occur in the ADF 18, but occurs both in the back side image reading sensor 2 and in the front side image reading sensor 3, the control unit 8 determines that the document cannot be continuously read because failure occurs both in the image reading sensors. In this case, the control unit 8 determines that an image cannot be read using the ADF 18 and the document laid on the document positioning plate cannot be read either. (Reading operation cannot be continued)

(4) If failure occurs in the ADF 18, but does not occur both in the back side image reading sensor 2 and in the front side image reading sensor 3, the document laid on the document positioning plate can be read using the front side image reading sensor 3, in which failure does not occur, and the document scanning unit. For this reason, after the image forming apparatus is restarted, the control unit 8 determines that the document laid on the document positioning plate can be read. (Reading operation can be continued)

(5) If failure occurs in the ADF 18 and the front side image reading sensor 3, but does not occur in the back side image reading sensor 2, the control unit 8 determines that reading operation cannot be continued because reading operation cannot be continued using the back side image reading sensor 2.

### (Reading Operation Cannot be Continued)

(6) If failure occurs in the ADF 18 and the back side image reading sensor 2, but does not occur in the front side image reading sensor 3, the document laid on the document positioning plate can be read using the front side image reading sensor 3, in which failure does not occur, and the document scanning unit. For this reason, the control unit 8 determines that the document laid on the document positioning plate can be read. In this case, after the image forming apparatus is restarted, the control unit 8 similarly determines that the document laid on the document positioning plate can be read irrespective of the occurrence of failure in the back side image reading sensor 2. (Reading operation can be continued)

(7) If failure occurs in the ADF 18, the back side image reading sensor 2, and the front side image reading sensor 3, the control unit 8 determines that an image cannot be continuously read because failure occurs in all of the image reading sensors. (Reading operation cannot be continued)

Thus, the control unit 8 can distinguish errors in reading a document based on the signal detected by the failure detection sensor 4 according to a failure place or a failure state. The control unit 8 distinguishes errors in which a part where failure does not occur can be operated without using only failed functions from errors in which the image forming apparatus itself cannot be used as long as a service man replaces failed components and performs control. The processing proceeds to step S203.

In step S203, the control unit 8 refers to the content of an error to determine whether the reading of the document can be continued by restarting the image forming apparatus. If the control unit 8 determines that the error corresponds to any of the above cases (1), (2), (4), and (6) based on the signal from the failure detection sensor 4 (YES in step S203), the control unit 8 determines that reading operation can be continued after the image forming apparatus is restarted.

On the other hand, if the control unit 8 determines that the error corresponds to any of the above cases (3), (5), and (7) based on the signal from the failure detection sensor 4, the control unit 8 determines that reading operation cannot be continued after the image forming apparatus is restarted (NO in step S203). If the control unit 8 determines that reading operation can be continued after the image forming apparatus is restarted (YES in step S203), the processing proceeds to step S204.

In step S204, the control unit 8 displays that the restart of the image forming apparatus allows the currently interrupted reading operation to be continued, using the liquid crystal display 10 of the display unit 9.

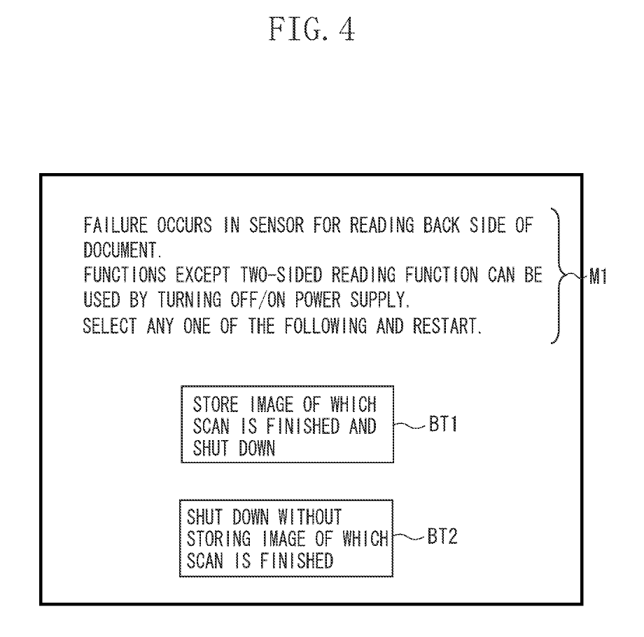

The control unit 8 further displays on the display unit 9 a user interface (UI), illustrated in FIG. 4 as an example, which inquires of the user whether the image data read by both of the reading sensors is stored until failure occurs in the image reading unit 1, as well as the display described above.

FIG. 4 illustrates an example of a user interface displayed on the display unit 9 illustrated in FIG. 1. The example corresponds to a restart selection screen for resuming reading using one sensor based on the determination of the control unit 8 according to the failure detected by the failure detection sensor 4 in step S203 illustrated in FIG. 3.

More specifically, FIG. 4 is an example of display in the case where it is determined that the reading of a document can be continued by restart processing using the reading function in which failure does not occurs in accordance with the failure determination result of the control unit 8. The user selects processing of read image data before the failure detection sensor 4 detects that failure occurs in a reading function.

In FIG. 4, a massage M1 notifies the user of an error. The massage M1 indicates that failure occurs in a reading sensor for reading the back side of a document. The massage M1 further notifies the user that functions except two-sided reading functions can be executed by turning off/on the power supply of the image forming apparatus to handle the failure.

A button BT1 is used to give an instruction to turn off the power supply of the image forming apparatus with the image stored in the image memory 5 until now in the reading process stored in the HDD 16 in response to the message M1. A button BT2 is used to give an instruction to turn off the power supply of the image forming apparatus without storing the image stored in the image memory 5 until now in the reading process in the HDD 16 in response to the message M1.

In the UI, when the user selects the button BT1, the scanned image data is stored in the HDD 16 based on the selection result before failure occurs and then the power supply of the image forming apparatus is turned off. The selection of the button BT1 means that the image data read by using the front side image reading sensor 3 and the back side image reading sensor 2 is stored in the HDD 16 and the restart processing is performed.

Although the example is described in which image data is stored in the HDD 16, image data may be stored in a nonvolatile memory instead of the HDD 16.

On the other hand, when the user selects the button BT2, the power supply of the image forming apparatus is turned off without storing the scanned image data before failure occurs. For this reason, when the user selects the button BT2, already read image data is deleted.

When the user selects the button BT2, the restart processing is performed without storing in the HDD 16 the image data read by using the front side image reading sensor 3 and the back side image reading sensor 2.

The processing proceeds to step S205. The control unit 8 determines whether the user selects the button BT1 to store the image data read before failure occurs in the HDD 16 with the user interface illustrated in FIG. 4 in step S204 displayed on the display unit 9. If the control unit 8 determines that the user selects the button BT1 (YES in step S205), the processing proceeds to step S206.

In step S206, the control unit 8 of the image forming apparatus stores the image data that is held in the image memory 5 in the HDD 16, restarts (shuts down) the image forming apparatus, and ends the present processing. Not only the image data read before failure occurs but also information about setting of a scan job, the number of the read pages and the existence of an interrupted scan job (reading operation) is also stored in the HDD 16.

If the control unit 8 determines that the user selects the user button BT2 not to store the image data read before failure occurs with the user interface in FIG. 4 displayed on the display unit 9 in step S204 (NO in step S205), the processing proceeds to step S207. In step S207, the control unit 8 restarts the image forming apparatus without storing in the HDD 16 the image data stored in the image memory 5, and ends the present processing.

In step S203, if the control unit 8 determines that merely restarting the image forming apparatus based on information from the sensor cannot continue reading operation (NO in step S203), the processing proceeds to step S208.

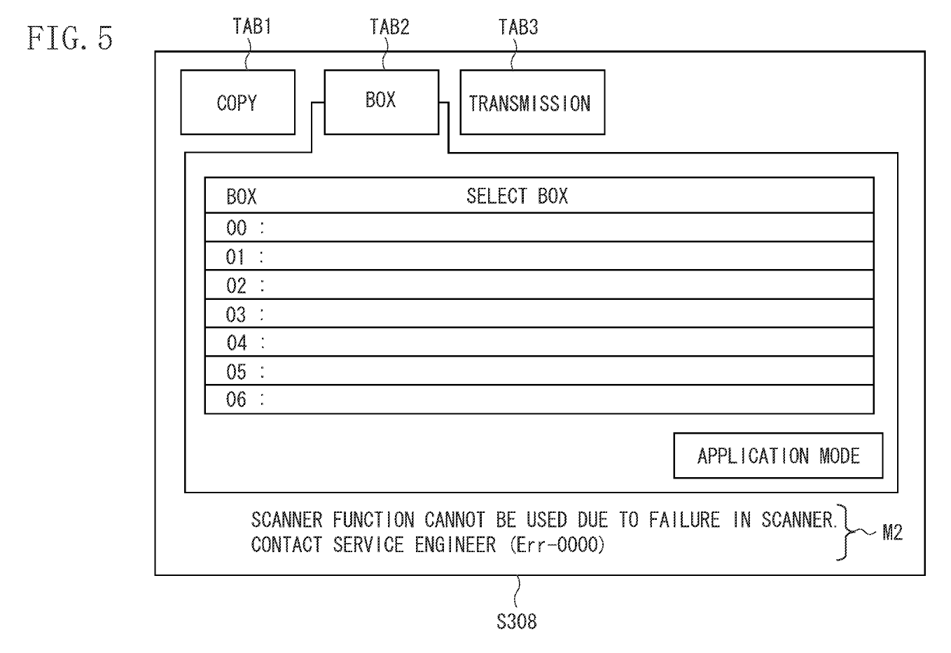

In step S208, on the liquid crystal display 10 of the display unit 9, the control unit 8 displays the occurrence of failure due to which the reading process cannot be resumed and the user interface illustrated in FIG. 5 indicating error codes and contact information for making inquiries to a service engineer.

FIG. 5 illustrates an example of a user interface displayed on the display unit 9 illustrated in FIG. 1. The example displays a message M2 on the display unit 9 that requests the user to contact a service engineer to solve the occurred failure. Thereafter the processing ends.

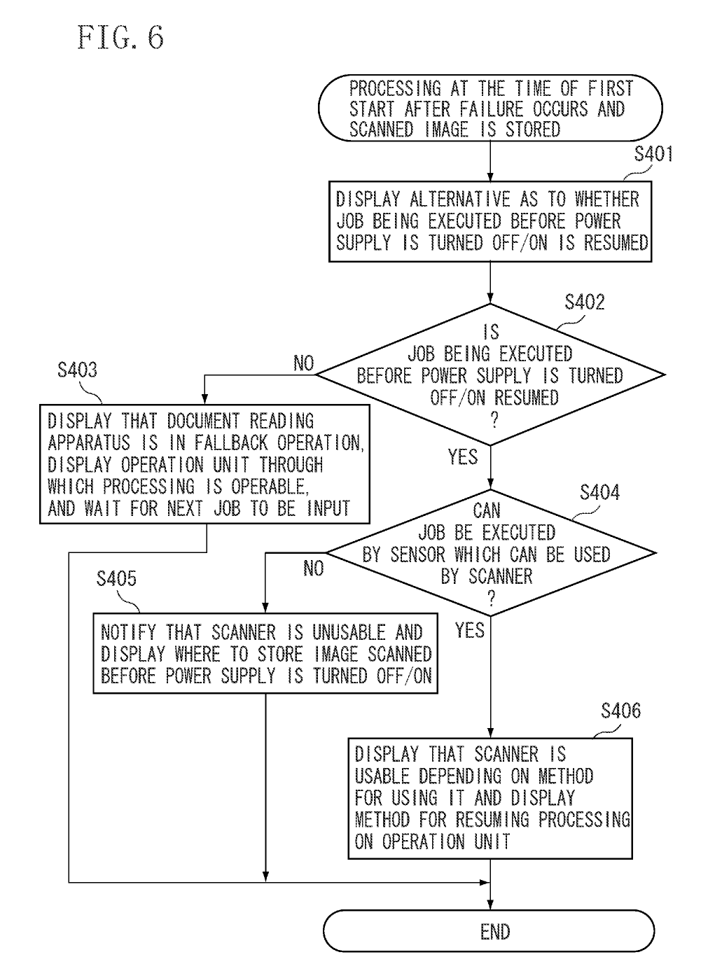

The processing performed after the image data stored before failure occurs is stored in the HDD 16, and the image forming apparatus is restarted in step S206 in FIG. 3 is described below with reference to FIG. 6.

FIG. 6 is a flow chart illustrating an example of data processing in a document reading apparatus according to the present exemplary embodiment. Steps S401 to S406 are realized by the control unit 8 loading the control program stored in the ROM 14 into the RAM 13 and executing it.

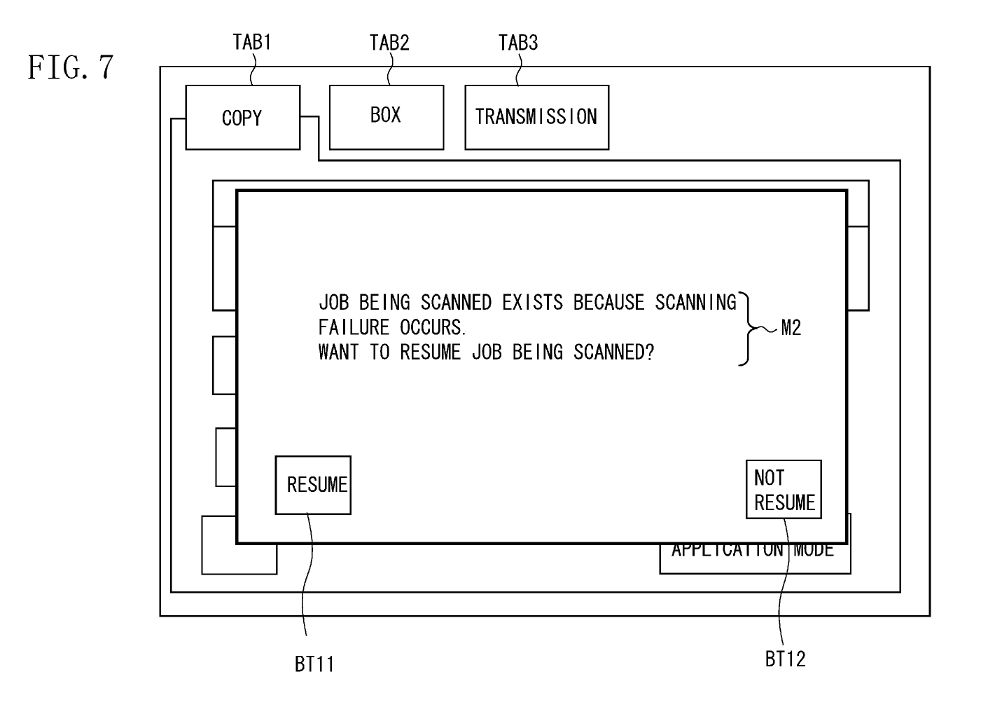

In step S401, the control unit 8 acquires a state before starting from the HDD 16 at the time of restart, and inquires the user whether to resume the reading operation executed before the restart if there exists a scan job (reading operation), which is being interrupted. For example, the control unit 8 inquires the user by displaying the user interface in FIG. 7 on the display unit 9.

FIG. 7 illustrates an example of the user interface displayed on the display unit 9 illustrated in FIG. 1. In the example, the user selects the button BT1 in step S205 (NO in step S205) and the image forming apparatus is shut down. After that, a document is read and stored before failure occurs while being scanned, and then the user is inquired whether a job including the interrupted reading of the document is resumed at the time of displaying an initial screen.

In FIG. 7, a message M2 inquires of the user whether a job is resumed. In response to the inquiry, the user selects the buttons BT11 or BT12 corresponding to whether to resume the job. Tabs TAB1 to TAB3 are used to select functions and correspond to copy, box, and transmission functions.

In step S402, the control unit 8 determines whether the user selects the button BT12 of the user interface. If the control unit 8 determines that the user does not select the button BT12 for resuming the reading operation executed before the restart (NO in step S402), the processing proceeds to step S403.

If the user does not select the button BT12, the user should select the button BT11 for not resuming a job.

In step S403, since the processing not using the document reading unit 1 (such as print, facsimile, and send) can be used, the reference path of image read before the image forming apparatus is restarted and the currently usable functions area displayed on the display unit 9. Then, the control unit 8 ends the processing, and waits for the next job.

If the control unit 8 determines that the user selects the button BT12 in the user interface illustrated in FIGS. 7 to resume the job executed before the restart (YES in step S402), the processing proceeds to step S404.

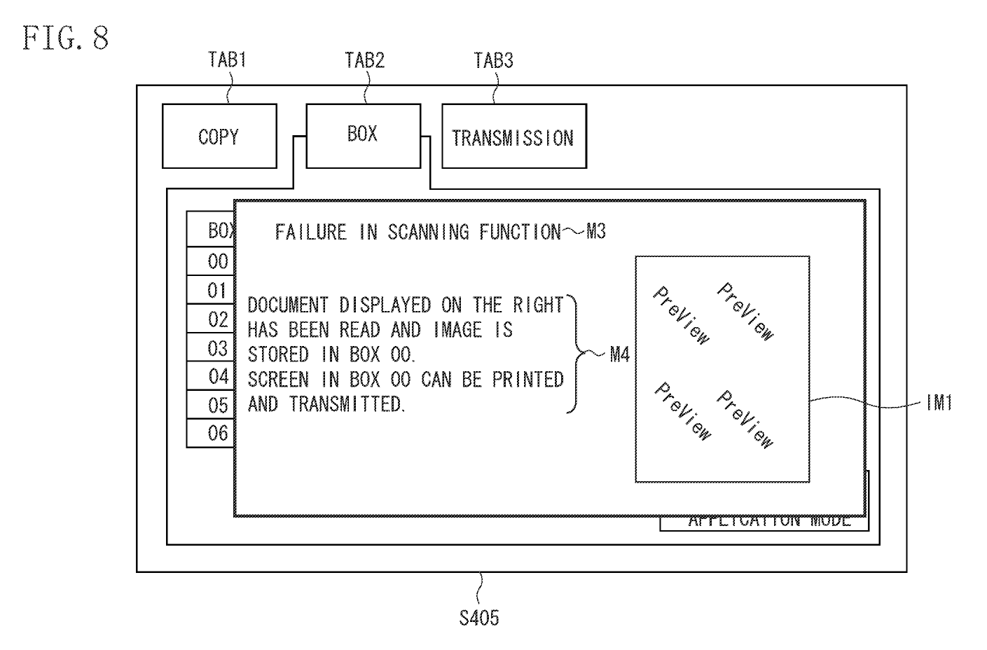

In step S404, the control unit 8 determines whether what function the failure detected by the failure detection sensor 4 influences. If the control unit 8 determines that the image reading apparatus cannot be used (NO in step S404), the processing proceeds to step S405. The control unit 8 displays the user interface illustrated in FIG. 8.

FIG. 8 illustrates an example of the user interface displayed on the display unit 9 illustrated in FIG. 1.

FIG. 8 corresponds to the user interface displayed on the display unit 9 in step S405, and illustrates an example message M3 that the scanner cannot be used, and an example message M4 that where the image data of the already read document is stored.

A box is a specific area in the HDD 16. The HDD 16 has a plurality of boxes. The plurality of boxes is provided with their respective serial numbers. The massage M4 indicates contents in which images provided with serial numbers are stored.

A preview image of the image of the document whose reading is completed at the latest among the images of the document stored in the HDD 16 is generated by the control unit 8, and displayed on the screen illustrated in FIG. 8. The user can easily confirm that reading of what document is completed.

If the control unit 8 determines that a part of the function of the document reading unit 1 is limited but the image reading function can be used to execute a job depending on a usage (YES in step s404), the processing proceeds to step S406.

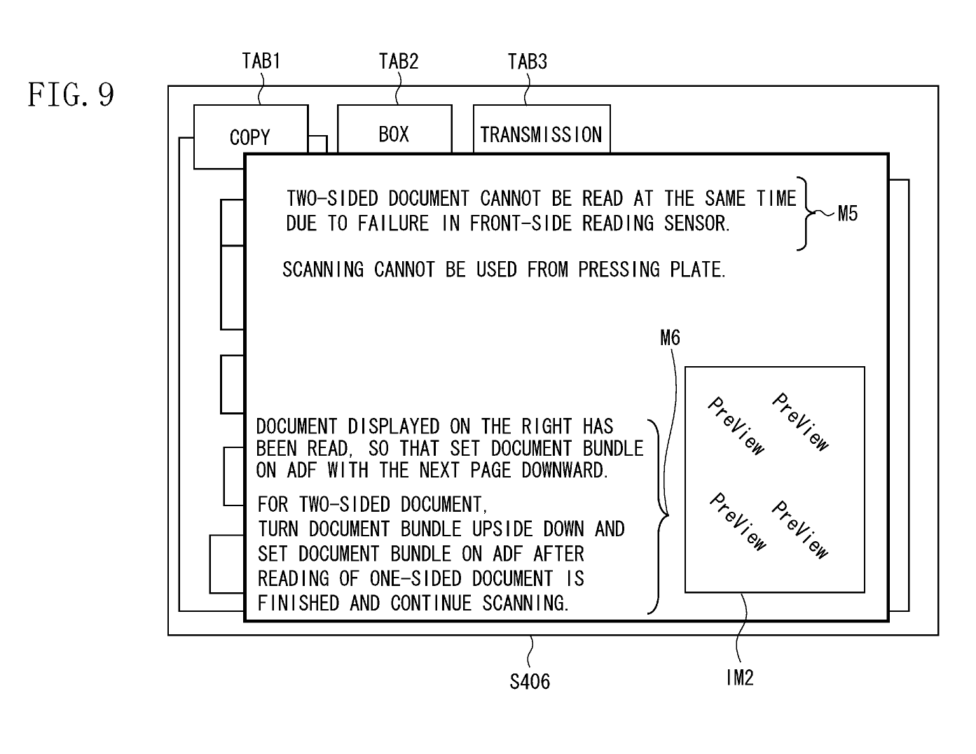

In step S406, the control unit 8 displays on the display unit 9 the user interface illustrated in FIG. 9 indicating that the scanner can be used depending on a usage, and an operating method for resuming the reading of an interrupted document. Then, the control unit 8 ends the processing.

FIG. 9 illustrates an example of the user interface displayed on the display unit 9 illustrated in FIG. 1. The example is the user interface illustrated in step S403, and indicates that the occurrence of failure restricts operations. A guide display processing is described below, which causes the user to continue the reading of a document by using any of the sensors if failure occurs.

In FIG. 9, a message M5 notifies the user of the current state of the image forming apparatus. In the example, the message M5 represents that a two-sided document cannot be read at the same time due to failure in the front side reading sensor 3. A message M6 represents that a part of the reading function is restricted because the other sensor is unusable, but a document can be read by using a usable sensor.

The message M6 further represents that one-sided document can be read using the ADF 18, and a document is turned upside down and read it one side by one side, resultantly showing that a two-sided document can be read.

As described above, in the present exemplary embodiment, if the control unit 8 determines that the reading operation can be continued by the image reading function based on the failure detected by the failure detection sensor 4, the control unit 8 perform control in the following manner. The control unit 8 notifies the user of a method of resuming the reading operation interrupted due to failure before the restart processing by a method whereby the apparatus can be operated according to the failure condition of the document reading unit 1 by using the display unit 9 of the image forming apparatus.

The method of resuming the reading operation is different according to the failure condition of the front side image reading sensor 3, the back side image reading sensor 2, or the automatic document feeder (ADF) 18.

If failure occurs in the front side image reading sensor 3, for example, the front side of a two-sided document cannot be read, however, the front side can be read using the back side image reading sensor 2 provided on the ADF 18. A substitute reading processing for the case where failure occurs in the front side image reading sensor 3 is described below with reference to the user interface illustrated in FIG. 9.

In the example illustrated in FIG. 9, the user confirms that failure occurs in the front side image reading sensor 3 on the massage M5. After that the user confirms a method of operation used for resuming the interrupted reading of a document based on the message M6. The message M6 functions as a message for instructing the user how to set a document.

If a document that the user intends to cause the sensor to read is a one-sided document, the document is laid on the document tray of the ADF 18 with the face of the document directed downward, and the start button on the display unit 9 is depressed, thereby allowing the document to be read by the back side image reading sensor 2 arranged on the document feeding path.

If a document that the user intends to cause the sensor to read is a two-sided document, the document is laid on the document tray with the face of the document opposite to that thereof previously read directed downward. The user presses the start button on the display unit 9 to allow images on the back side of the document to be read by the back side image reading sensor 2.

The control unit 8 of the image forming apparatus controls the image processing unit 6 to read the image data already read before the restart from the HDD 16, and combine it with the image data read after the restart. Thereby an editing process is executed in which all of the read image data are combined into one document data.

On the other hand, if failure occurs in the back side image reading sensor 2, images on the back side of a document cannot be read because of structural constraints of the image forming apparatus described with reference to FIG. 2. However, a document can be read by the following method.

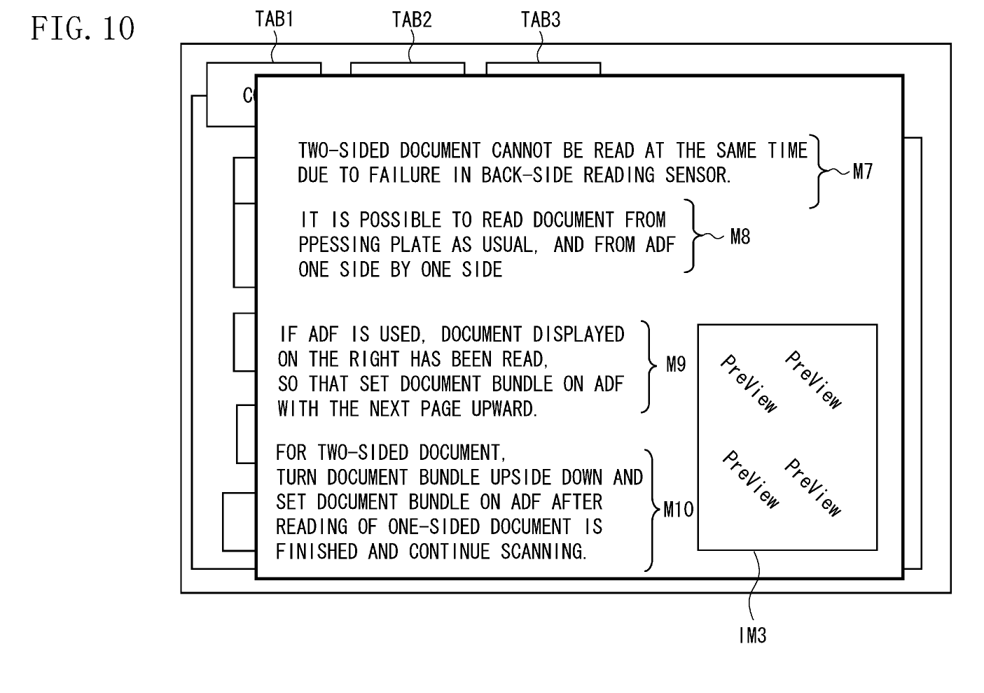

If a document is a one-sided, the document is laid on the document tray of the ADF 18 with the face of the document desired to be read directed upward, and the start button on the display unit 9 is pressed, thereby allowing the document to be read in the reading position by using the front side image reading sensor 3. The control unit 8 displays messages M7 to M10 of the user interface illustrated in FIG. 10 on the display unit 9. The messages M9 and M10 function as messages for instructing the user how to set a document.

FIG. 10 illustrates an example of the user interface displayed on the display unit 9 illustrated in FIG. 1. The example corresponds to the case where the reading of a document is continued only by using the front side image reading sensor 3. The user can surely conduct a series of operations while confirming the user interface displayed on the display unit 9. A guide display processing is described below, which prompts the user to continue the reading of a document by using any of the sensors if failure occurs.

In FIG. 10, a message M7 represents that failure occurs in the back side image reading sensor 2. A message M8 represents that scanning can be performed from a pressing plate and a document can be fed from the ADF even under the present failure condition.

A message M9 represents that how a document is set when the ADF is used. A message M10 represents that how a two-sided document is set. The user confirming these messages can cause the apparatus to read the interrupted document.

If the user intends to cause the front side image reading sensor to read a two-sided document according to the message M10, the user lays the document on the document tray with the face of the document opposite to that thereof previously read directed upward. The user presses the start button on the display unit 9 to allow images on the back side of the document to be read by using the front side image reading sensor 3.

A document desired to be read is laid on the flat bed reading unit page by page without using the automatic document feeder (ADF) 18 with the face of the document directed downward. The user presses the start button on the display unit 9 to allow the document to be read by using the front side image reading sensor 3.

The control unit 8 of the image forming apparatus controls the image processing unit 6 to read the images of the document already read before the restart from the HDD 16, and combine them with the images read after the restart. Thereby the control unit 8 combines the all read images of documents with each other to create one file (document).

If failure occurs in the automatic document feeder (ADF) 18, a document cannot be automatically conveyed and the back side image reading sensor 2 positioned on the automatic document feeder cannot be used either.

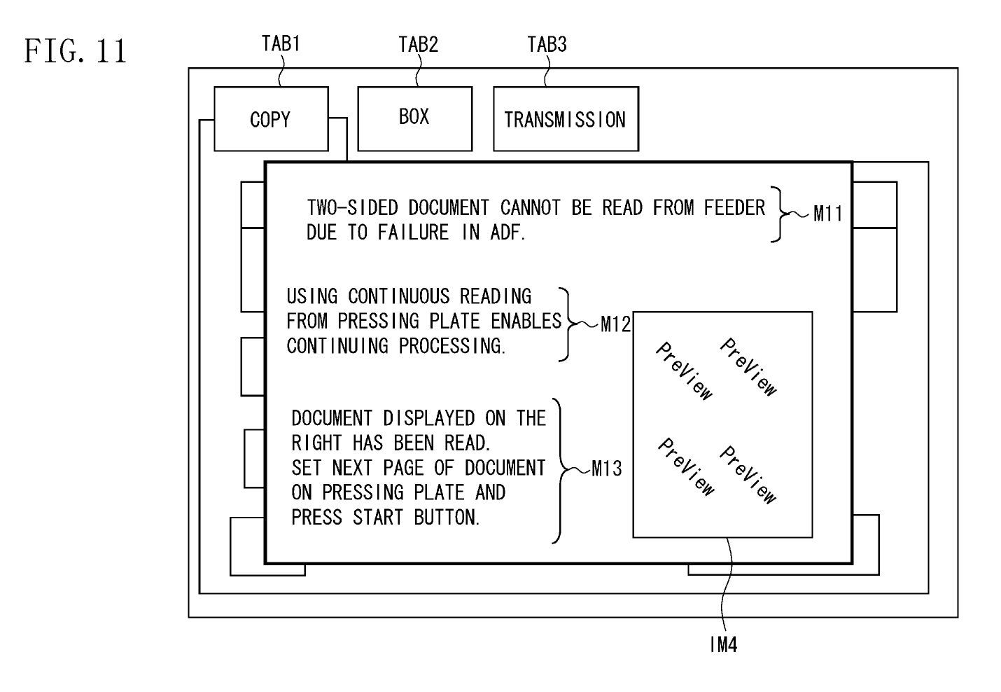

FIG. 11 illustrates an example of the user interface displayed on the display unit 9 illustrated in FIG. 1. The example corresponds to the case where the reading of a document is continued by using only the front side image reading sensor 3 because failure occurs in the ADF 18. The user can surely conduct a series of operations while confirming the user interface displayed on the display unit 9.

A guide display processing is described below, which prompts the user to continue the reading of a document by using any of the sensors if failure occurs.

In FIG. 11, a message M11 represents that failure occurs in the ADF 18. A message M12 represents that scanning can be performed from a pressing plate irrespective of the present failure condition.

A message M13 represents that how a document is set in the case where the document is read without using the ADF 18. The message M13 further represents that how the document is set to resume reading. The message M13 functions as a message for instructing the user how to set a document.

If the reading of a document is resumed without using the ADF 1, a document desired to be read is laid on the document positioning plate page by page with the face of the document directed downward, and the start button on the display unit 9 is pressed. This allows the document to be read at the reading position by using the front side image reading sensor 3. In this case, the front side image reading sensor 3 reads an image reflected from a document while the optical system of the scanner unit scans in a predetermined direction.

The control unit 8 of the image forming apparatus controls the image processing unit 6 to read the image data already read before the restart from the HDD 16, and combine it with the image data read after the restart. Thereby the control unit 8 combines all of the read images with each other to create one document.

As described above, if failure occurs in a part of the image reading apparatus while a document is being read, image data read before the failure occurs is stored in a nonvolatile memory, and the image reading apparatus can be restarted.

The user can select whether image data read before failure occurs is stored. If the user determines that the image data read before failure occurs is not required, the user restarts the image forming apparatus without storing the image data in the HDD 16 to save the capacity thereof.

Only the function of the image reading apparatus in which failure does not occurs while a document is being read is used to operate the image forming apparatus, and a reading job which is being interrupted is resumed. The user can be notified of a user-friendly operation method for resuming the interrupted reading of a document using the user interface, which makes an operation easy for resuming the reading of a document.

If the interrupted reading of a document is resumed, image areas IM1 to IM4 where the already read image data of a document is previewed are displayed on the user interfaces, so that the user can confirm that what document has been already and normally read. If the reading of a plurality of documents is resumed, the user may set the document next to the already read document, and cause the apparatus to resume reading.

The above control allows providing the user with the functions of the image forming apparatus to the maximum even if failure occurs in a part of the image reading apparatus, and minimizing disadvantage that the user suffers from failure.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-181312 filed Aug. 4, 2009, which is hereby incorporated by reference herein in its entirety.

What is claimed is:

1. An image reading apparatus comprising:
a reading unit configured to execute a reading operation in which a first side of a document conveyed by an automatic document feeder is read by using a first reading unit and a second side of the document is read by using a second reading unit;
a determining unit configured to determine whether the reading operation can be resumed by using the first reading unit or the second reading unit by restarting the image reading apparatus if failure occurs in at least one of the first reading unit and the second reading unit during the reading operation; and
a control unit configured to cause a nonvolatile memory to store an image of the read document and the image reading apparatus to restart if reading operation can be resumed.

2. The image reading apparatus according to claim 1, further comprising a selecting unit configured to select whether or not the image of the read document among images of the documents is stored in the nonvolatile memory and whether the image reading apparatus is restarted in accordance with an instruction if the reading operation can be resumed,
wherein if the selecting unit selects that the image is stored in the nonvolatile memory and the image reading apparatus is restarted, the control unit stores the image in the nonvolatile memory and restarts the image reading apparatus, and
if the selecting unit selects that the image is not stored in the nonvolatile memory and the image reading apparatus is restarted, the control unit does not store the image in the nonvolatile memory and restarts the image reading apparatus.

3. The image reading apparatus according to claim 1, further comprising a display control unit configured to cause a display unit to display a setting screen for resuming the reading operation by using the reading unit in which failure does not occur among the first and the second reading units after the image reading apparatus is restarted.

4. The image reading apparatus according to claim 3,
wherein the display control unit causes the display unit to display a message indicating a method for reading both sides of the document by using the second reading unit if failure occurs in the first reading unit or by using the first reading unit if failure occurs in the second reading unit.

5. The image reading apparatus according to claim 3,
wherein the display control unit causes the display unit to display a message indicating a method for reading both sides of the document by using the first reading unit if failure due to which the document cannot be conveyed occurs in the automatic document feeder.

6. The image reading apparatus according to claim 1, further comprising a combining unit configured to combine images of the document newly read by the first reading unit or the second reading unit with the stored image after the control unit restarts the image reading apparatus.

7. A control method for controlling an image reading apparatus, the control method comprising:
executing a reading operation in which a first side of a document conveyed by an automatic document feeder is read by using a first reading unit and a second side of the document is read by using a second reading unit;
determining whether the reading operation can be resumed by using the first reading unit or the second reading unit by restarting the image reading apparatus if failure occurs in at least one of the first reading unit and the second reading unit during the reading operation;
selecting whether the image of the read document is stored in the nonvolatile memory and the image reading apparatus is restarted, or the image is not stored in the nonvolatile memory and the apparatus is restarted if it is determined that the reading operation can be resumed; and
causing the image reading apparatus to restart according to a selection result.

8. The control method according to claim 7, further comprising selecting whether or not the image of the read document among images of the documents is stored in the nonvolatile memory and whether the image reading apparatus is restarted in accordance with an instruction if the reading operation can be resumed;
storing the image in the nonvolatile memory and restarting the image reading apparatus if the selecting selects that the image is stored in the nonvolatile memory and the image reading apparatus is restarted; and
restarting the image reading apparatus if the selecting selects that the image is not stored in the nonvolatile.

9. The control method according to claim 7, further comprising displaying a setting screen for resuming the reading operation by using the reading unit in which failure does not occur among the first and the second reading units after the image reading apparatus is restarted.

10. The control method according to claim 9, further comprising
displaying a message indicating a method for reading both sides of the document by using the second reading unit if failure occurs in the first reading unit or by using the first reading unit if failure occurs in the second reading unit.

11. The control method according to claim 9, further comprising displaying a message indicating a method for reading both sides of the document by using the first reading unit if failure due to which the document cannot be conveyed occurs in the automatic document feeder.

12. The control method according to claim 7, further comprising combining images of a document newly read by the first reading unit or the second reading unit with the stored image after the control unit restarts the image reading apparatus.

13. A computer readable recording medium for storing a computer program for controlling an image reading apparatus, the computer readable recording medium comprising:
a code to execute a reading operation in which a first side of a document conveyed by an automatic document feeder is read by using a first reading unit and a second side of the document is read by using a second reading unit;
a code to determine whether the reading operation can be resumed by using the first reading unit or the second reading unit by restarting the image reading apparatus if failure occurs in at least one of the first reading unit and the second reading unit during the reading operation;
a code to select whether the image of the read document is stored in the nonvolatile memory and the image reading apparatus is restarted, or the image is not stored in the nonvolatile memory and the image reading apparatus is restarted if the reading operation can be resumed; and
a code to cause the image reading apparatus to restart according to a selection result.

14. The computer readable recording medium according to claim 13, further comprising:
a code to select whether or not the image of the read document among images of the documents is stored in the nonvolatile memory and whether the image reading apparatus is restarted in accordance with an instruction if the reading operation can be resumed;
a code to store the image in the nonvolatile memory and restarting the image reading apparatus if the selecting selects that the image is stored in the nonvolatile memory and the image reading apparatus is restarted; and
a code to restart the image reading apparatus if the selecting selects that the image is not stored in the nonvolatile.

15. The computer readable recording medium according to claim 13, further comprising a code to display a setting screen for resuming the reading operation by using the reading unit in which failure does not occur among the first and the second reading units after the image reading apparatus is restarted.

16. The computer readable recording medium according to claim 15, further comprising a code to display a message indicating a method for reading both sides of the document by using the second reading unit if failure occurs in the first reading unit or by using the first reading unit if failure occurs in the second reading unit.

17. The computer readable recording medium according to claim 15, further comprising a code to display a message indicating a method for reading both sides of the document by using the first reading unit if failure due to which the document cannot be conveyed occurs in the automatic document feeder.

18. The computer readable recording medium according to claim 13, further comprising a code to combine images of a document newly read by the first reading unit or the second reading unit with the stored image after the control unit restarts the image reading apparatus.
